(19) United States
(12) Patent Application Publication
(10) Pub. No.: US 2012/0118121 A1
(43) Pub. Date: May 17, 2012

(54) MITER SAW WITH WORKING LAMP

(75) Inventors: Kesong Xu, Ningbo (CN); Yun Huang, Nanjing (CN)

(73) Assignee: CHERVON (HK) LIMITED, Wanchai (HK)

(21) Appl. No.: 13/288,333

(22) Filed: Nov. 3, 2011

(30) Foreign Application Priority Data
Nov. 17, 2010 (CN) 201020610938.2

(51) Int. Cl. B27B 27/06

(52) U.S. Cl. 83/471.3

(57) ABSTRACT

A miter saw, comprising a base, a worktable for carrying a work piece to be cut, a cutting head pivotally connected to the worktable and positioned in a working position and a stopping position, and a self-hung type working lamp coupled to the cutting head. In one example, a main handle has a rotating pivot on which the self-hung type working lamp is rotatably arranged. The self-hung type working lamp may comprise at least one light source for consistent irradiation of the cutting area upon being powered. The present device further enables the working lamp to rotate with the up and down movement of the cutting head to substantially irradiate the same cutting area to keep the stability of the lighting. It can also achieve the control of the irradiating area with a simple structure and without affecting the overall appearance of the machine.

### CROSS REFERENCE TO RELATED APPLICATION

This application is a non-provisional application claiming priority from Chinese Patent Application Serial No. CN 201020610938.2, filed Nov. 17, 2010, and incorporated herein by reference in its entirety.

### FIELD OF THE DISCLOSURE

The present disclosure relates generally to a miter saw, and more particularly to a miter saw with a working lamp.

### BACKGROUND OF RELATED ART

In the use of a miter saw, the operation environment may be changed due to different working conditions. When used in the environment where the lighting, such as daylight, etc. is not sufficient, such as in a basement, some miter saws may be provided with an added lighting device for the worktable on the machine, referred to as working lamp. Considering the designs for structure and shape of the common miter saws, the working lamp is generally arranged at the position of the cutting head.

For example, referring to FIGS. 5 and 6, due to the structure features of the miter saw, the cutting head typically performs a rotating motion with a supporting arm during the cutting process. Because the working lamp is fixed on the cutting head, when the cutting head is positioned in a working position at the lowest position (FIG. 5) and in a stopping position at the highest position (FIG. 6), respectively, the working lamp may be rotated with the rotation of the cutting head, which results in that the irradiating angle of the working lamp is changed continuously, and the irradiating area is also changed continuously during the cutting process. Accordingly, in some instance, the working lamp is moved to the outside of the whole worktable, which causes a flickering lighting effect, thus it is not suitable for the operator to work with.

### SUMMARY

In order to overcome at least some of the deficiencies in the prior art, the presently disclosed miter saw is provided with a lamp, such as a spotlight, which may ensure stability of the lighting area during the up and down rotation of the cutting head without adding to the complexity of the machine.

In still other examples the miter saw of the present disclosure comprises worktable components for carrying a work piece to be cut, a cutting head pivotally connected to the worktable components, wherein the cutting head may be positioned in a working position and a stopping position, and provided with a self-hung type working lamp.

The example working lamp may comprise at least one light source which may irradiate a cutting area stably upon being powered.

The example working lamp may comprise a DC power or be connected to a power of the miter saw through a rectifying voltage-reduced circuit.

The example cutting head may comprise a circular saw blade, a stationary shield for partly covering the circular saw blade, and a main handle connected to the stationary shield, and the self-hung type working lamp is mounted on the main handle or the stationary shield.

The example self-hung type working lamp may comprise a lamp shell for disposing the light source, a rotating shaft for mounting to the cutting head and a heavy object having a density of material greater than that of the lamp shell.

The example self-hung type working lamp may comprise a buffering member arranged on one side thereof.

The example self-hung type working lamp may be rotatably mounted to the cutting head around a rotating axis.

The example self-hung type working lamp may be pivotally mounted to the cutting head around a rotating pivot.

The example self-hung type working lamp may comprise a lamp shell portion for disposing the light source, a rotating shaft for mounting to the cutting head and a heavy portion distributing the gravity and having a weight greater than that of the lamp shell portion.

The example cutting head may be provided with a stopping member for restricting the moving range of the self-hung type working lamp so as to protect the self-hung type working lamp from damage due to overlarge swing amplitude in the case that the machine is inclined, for example, during the conveyance, and also ensure the wiring of the power supply cord without winding and keep the stability of the irradiating direction.

The example worktable components may include a base and a worktable rotatably mounted to the base.

Accordingly, in at least one example, the technical effect obtained by the present disclosure includes: with the function of the gravity field, the irradiating direction of the working lamp may be controlled, which solves the problem of flickering, simplifies the structure, decreases the corresponding assistant members, and reduces the corresponding cost; it may be directly arranged in a closed space, which assists in the shape control, and the shape can not be affected by the redundant structures.; and the position of the working lamp is not restricted by the structure, thus it has less restriction for the structure.

### BRIEF DESCRIPTION OF THE DRAWINGS

FIG. 1 is a schematic view of an example miter saw according to the present disclosure in a working position;

FIG. 2 is a schematic view of the example miter saw of FIG. 1 in a stopping position;

FIG. 3 is a schematic view of the example miter saw of FIG. 1, showing the mounting position of a self-hung type working lamp;

FIG. 4 is a schematic view of the example self-hung type working lamp of the miter saw of FIG. 1; and

FIGS. 5 and 6 are schematic views of a prior art miter saw with a spotlight.

### DETAILED DESCRIPTION

One example of a technical solution of the present disclosure will be described with reference to the example embodiment shown in the drawings.

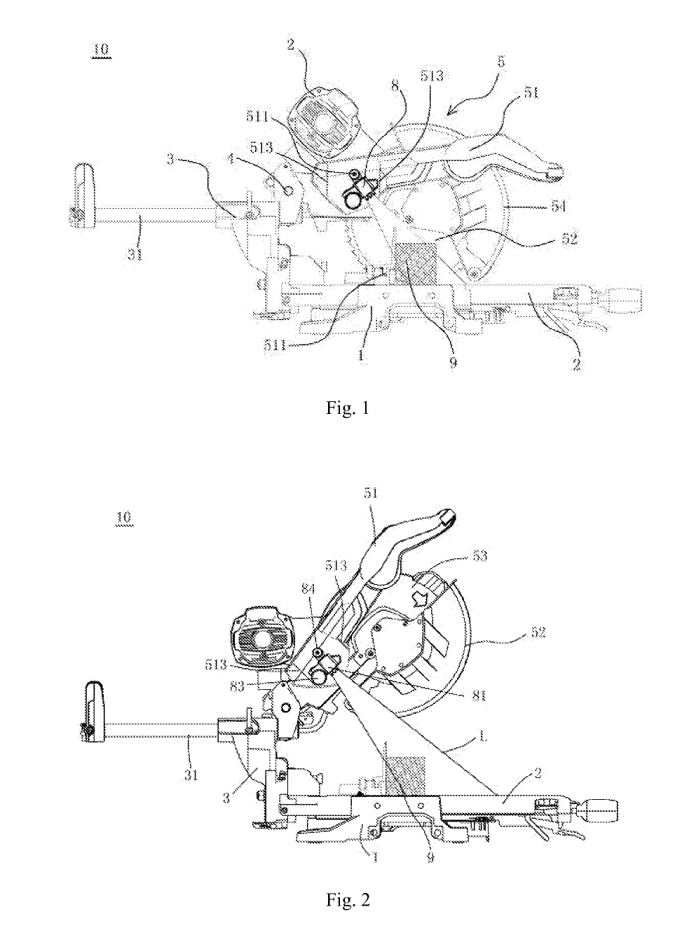

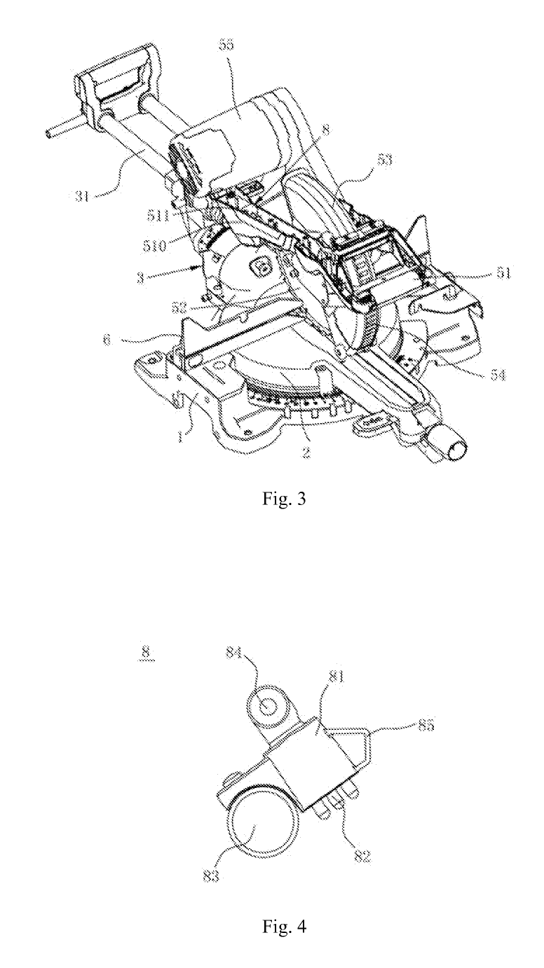

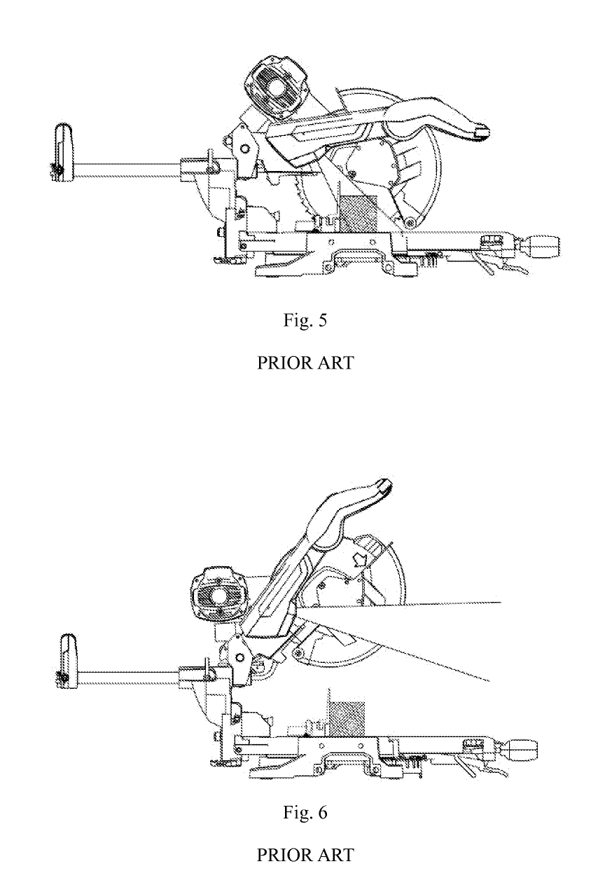

FIGS. 1, 2, 3, and 4 show one embodiment of a miter saw 10 according to the present disclosure, which comprises a base 1, a worktable 2 rotatably mounted to the base 1, a cutting head 5, and a supporting arm 3 for connecting the cutting head 5 to one end of the worktable 2. The base 1 and the worktable 2 form worktable components for carrying a work piece 9 to be cut. The cutting head 5 has a pivoting shaft 4 as an axis, and may be rotated between a working position (shown in FIG. 1) and a stopping position (shown in FIG. 2) with regard to the worktable components. The cutting head 5 has a main handle 51, a circular saw blade 52, a stationary shield 53, a movable shield 54 and a motor 55, wherein the main handle 51 is used to change the position of the cutting head 5 and perform a cutting operation, the stationary shield 53 is fixedly mounted on the upper portion of the circular saw blade 52 for protection, the movable shield 54 is mounted on the lower portion of the circular saw blade 52 and can be swung for protection, and the motor 55 is used to drive the circular saw blade 52 to perform a cutting operation. The miter saw 10 is also provided with a fence device 6 for supporting the work piece 9 to be cut together with the worktable components and a self-hung type working lamp 8 for providing a working area with assistant lighting during the cutting process, wherein the irradiating direction cannot be significantly changed with the changes of the relative positions of the cutting head 5 and the worktable 2.

In the present example, the base 1 and the worktable 2 may rotate relative to one another so as to provide a miter cutting function. The supporting arm 3 may cause the cutting head 5 to swing towards left and right sides or one side with regard to the worktable 2 so as to provide a bevel cutting function. The cutting head 5 may slide forward and backward along a guide rail 31 so as to provide a linear cutting function. These functions may be achieved separately or in combination in some examples, and the structures for achieving these functions are understandable to one of ordinary skill in the art.

The self-hung type working lamp 8 of the present example comprises a lamp shell 81, a light source 82, a heavy object 83, and a rotating shaft 84, wherein the light source 82 may be taken the form of a LED and so on, the lamp shell 81 may be formed by a material having a smaller density such as plastic, and the heavy object 83 may be formed by a material having a greater density such as iron, thus the light emitted form the light source 82 may irradiate a portion of the worktable 2 where the work piece 9 is positioned with the aid of the gravity traction of the heavy object 83, thereby facilitating the cutting operation. The rotating shaft 83 has a through hole through which the self-hung type working lamp 8 may be mounted to a rotating shaft 511 in a housing 510 of the main handle 51, so that the self-hung type working lamp 8 may swing freely under the function of gravity. The bottom of the housing 510 of the main handle 51 opposite to the light source 82 is provided with an opening or formed with transparent material so that the light emitted from the self-hung type working lamp 8 may penetrate therethrough and irradiate the worktable 2.

In other alternative examples, the lamp shell and the heavy object may be formed by the same material. In that case, the emitted light can be ensured to irradiate the desired area on the worktable under the function of the gravity by distributing the weight of the self-hung type working lamp, for example, the lamp shell may be formed with a hollow design, and the heavy object may be formed as a solid design. The self-hung type working lamp may further comprise a DC power or be connected to a power of the motor of the miter saw through a rectifying voltage-reduced circuit.

Referring to FIG. 4, as the self-hung type working lamp 8 swings around the rotating shaft 84 during the cutting process, a buffering member 85 is provided on the exterior of the lamp shell 81 in order to prevent the self-hung type working lamp 8 from interfering with other portions in the housing 510 of the main handle 51 and thereby damaging the light source 82 due to the overlarge swing amplitude. The buffering member 85 may be formed with elastic material such as plastic or be designed as an easily deformable shape so as to perform a buffering function when a strong collision occurs to reduce the damage to the light source 82. Depending on the specific circumstance, a same buffering structure may be arranged on the other side of the self-hung type working lamp 8, or a buffering wall 513 (shown in FIGS. 1 and 2) may be simultaneously or separately arranged in the housing 510 of the main handle 51, thus the self-hung type working lamp 8 is protected from a strong collision in the housing 510. The buffering wall may also be used as a stopping member to restrict the moving range of the self-hung type working lamp 8.

Next, the working process of the miter saw 10 is described with reference to FIGS. 1 and 2. In operation, when the cutting head 5 is located in the working position, the stopping position or any position between the working position and the stopping position, the direction of the heavy object 82 of the self-hung type working lamp 8 is kept constant under the function of gravity. Thus the self-hung type working lamp 8 may be kept in one direction by rotating around the rotating shaft 511 through the rotating shaft 84, so that the irradiating direction of the light L emitted from the self-hung type working lamp 8 is also constantly kept in a desired direction, and the irradiating area is constantly kept in a certain angle range. Therefore, whatever the cutting head 5 is positioned in the lowest position of the stroke, the highest position of the stroke or any position between the lowest position and the highest position, the light emitted from the self-hung type working lamp 8 can substantially direct to the cutting area without significantly changing the direction to cause a flickering in the working area.

The self-hung type working lamp 8 is arranged in the housing 510 of the main handle 51, which facilitates the control of the shape, and the shape can not be affected by the redundant structures. In other examples, the self-hung type working lamp 8 may also be arranged in other positions of the cutting head 5, for example, it may be rotatably mounted on one side of the stationary shield 51, which may obtain the same effect.

It will be readily conceivable by one of ordinary skill in the art that the self-hung type working lamp 8 of the present disclosure may also be used for other cutting tools except for the miter saw.

The above contents describe various examples of the present disclosure. It will be understood that there are numerous varieties and modifications of the examples which will be readily conceivable to one of ordinary skill in the art without departing from the technical principle of the present disclosure. These varieties and modifications are intended to be within the protection scope of the present disclosure and the present claims.

We claim:

1. A miter saw, comprising:
a worktable for carrying a work piece to be cut;
a cutting head pivotally connected to the worktable, wherein the cutting head may be positioned in a working position and a stopping position with regard to the worktable; and
a self-hung type working lamp coupled to the cutting head.

2. The miter saw according to claim 1, wherein the self-hung type working lamp comprises at least one light source for irradiating a cutting area stably upon being powered.

3. The miter saw according to claim 2, wherein the self-hung type working lamp further comprises a power supply.

4. The miter saw according to claim 3, wherein the power supply is at least one of a DC power supply, or a power supply of the miter saw comprising a rectifying voltage-reduced circuit.

5. The miter saw according to claim 3, wherein the cutting head comprises:
a circular saw blade;
a stationary shield for partly covering the circular saw blade; and
a main handle connected to the stationary shield, and
wherein the self-hung type working lamp is mounted on at least one of the main handle or the stationary shield of the cutting head.

6. The miter saw according to claim 5, wherein at least one of the main handle or the stationary shield is provided with at least one stopping member for restricting the moving range of the self-hung type working lamp.

7. The miter saw according to claim 1, wherein the self-hung type working lamp comprises:
a lamp shell portion for disposing a light source;
a rotating shaft for mounting to the cutting head; and
a heavy portion distributing gravity and having a weight greater than that of the lamp shell portion.

8. The miter saw according to claim 7, wherein the self-hung type working lamp comprises a buffering member arranged on one side thereof

9. The miter saw according to claim 8, wherein the self-hung type working lamp is rotatably mounted to the cutting head around a rotating axis.

10. The miter saw according to claim 8, wherein the self-hung type working lamp is pivotally mounted to the cutting head around a rotating pivot.

11. The miter saw according to claim 1, wherein the self-hung type working lamp comprises a lamp shell for disposing the light source, a rotating shaft for mounting to the cutting head and a heavy object having a density of material greater than that of the lamp shell.
